(19) United States
(12) Patent Application Publication
(10) Pub. No.: US 2020/0020192 A1
(43) Pub. Date: Jan. 16, 2020

(54) AUTHORIZE PARKING SYSTEM

(71) Applicants: Hoon Pooi Lee, Negeri Sembilan (MY); Yong Hern Lee, Negeri Sembilan (MY); Tze Kai Siow, Selangor (MY)

(72) Inventors: Hoon Pooi Lee, Negeri Sembilan (MY); Yong Hern Lee, Negeri Sembilan (MY); Tze Kai Siow, Selangor (MY)

(21) Appl. No.: 16/334,878

(22) PCT Filed: Sep. 23, 2016
(86) PCT No.: PCT/MY2016/000061

§ 371 Date: Mar. 20, 2019

(51) Int. Cl. G07F 17/24; G08G 1/14; G08G 1/04

(52) U.S. Cl. CPC G07F 17/24; G08G 1/146; G08G 1/04; G08G 1/142; G08G 1/149

(57) ABSTRACT

Authorize parking system has equipment such as main frame (A) in the form of an L-shape pillar where at the end of the frame allocated also the sensing/detector device (B) which is to detect the underneath vehicle. Warning light (C), which works by emitting a warning light and can also be sound the siren to attract attention and card reader (D) that acts as the heart of this system will detect smartcard shown to it and would send a signal to the indicator light (E) to open the parking space. Red light at indicator light as to notice close the parking space when not in use and will open (Green light) the parking space when received a signal from the card reader (D). If the indicator light is red in colour meant it is hit by an unauthorized driver without receiving instructions from the card reader (D), warning light (C) will work and this will attract attention authority to act. Once the driver is leaving the parking lot and object detector detect no vehicle, indicator light will closed back the parking space in red light noticed. The entire system is running using a solar power which is turn sunlight in to electricity and for internal building area system will works using electricity supply. Tyre stopper (H) is working to limit the distance a vehicle with a main frame (A) to avoid collision also damage. Optional accessories are included in this system such as LED light, cctv, intercom etc.

### TECHNICAL FIELD

The invention is intended to protect parking lots that have been reserved for particular persons (the authorities, the disable, the owner of the building, the owner of apartment, people interested etc.)

### BACKGROUND OF THE INVENTION

Reserved parking lots are only offered for those particular people. However, it is often being abused by irresponsible parties. This issue has caught public attentions especially when it involved the misused of disability parking; unfortunately, no solutions were made to solve this problem.

This particular issue is frequently covered in the local newspaper and social media. It raises the public awareness and concerns about this issue. Penalty has been imposed for those who have broken the law. However, the law and penalty had little effect as the records shown the increasing number of cases every year.

There is a need for a method to address this issue and this system is meant to address the problem of abusing the parking spaces especially for the disable.

### BRIEF DESCRIPTION OF THE DRAWINGS

The detailed description may be better understood with reference to the accompanying figures that are provided for illustrative purposes and are not to be considered limiting any aspect of the invention, in which:

FIG. 1 shows the position and installation of the devices of the parking system, according to the present invention.

FIG. 2 shows a flow chart indicating the operation of the parking system, according to the present invention.

### DETAILED DESCRIPTION OF THE INVENTION

### Elements of the Parking System:

| | |
|---|---|
| Main Frame | A |
| Sensing Device/Detector Device | B |
| Warning Light & Siren | C |
| Card Reader | D |
| Indicator Light | E |
| Solar Panel | F |
| Precast Concrete | G |
| Tire Stopper | H |
| CCTV | Not shown |
| LED Light | Not shown |
| Intercom | Not shown |

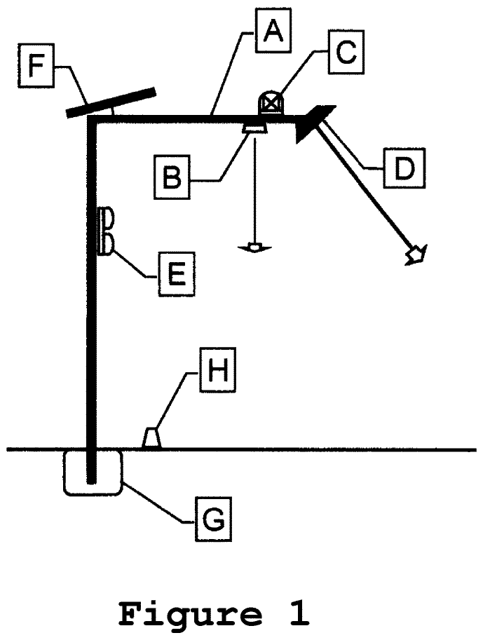

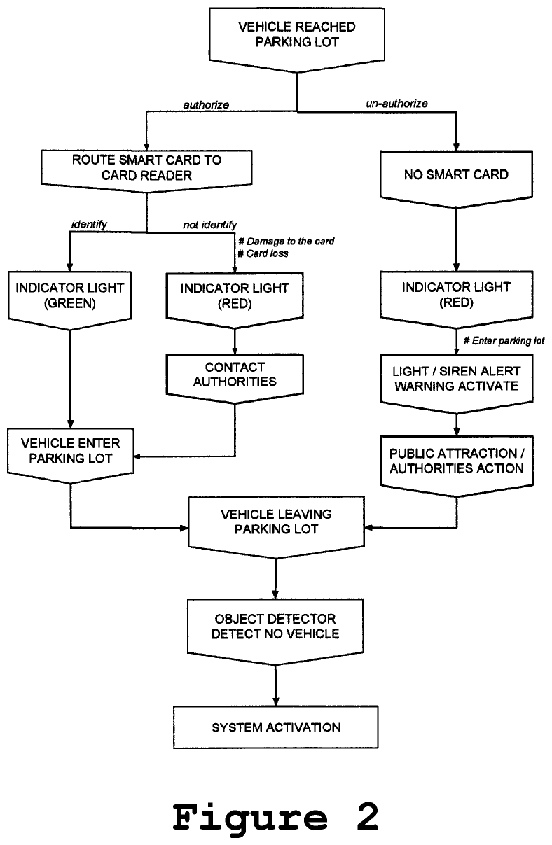

The invention will be explained in conjunction with FIG. 1 and FIG. 2. In operation, the system is started with a smartcard. It requires a driver to wave or show the smartcard towards the card reader (D) to legally enter the reserved parking. The card reader (D) is located at the top of the main frame (A) and the length of the detection is within 3 meters. The main frame (A) is supported to the ground by precast concrete (G). Once the card reader (D) detected the smartcard, a signal will be sent to the indicator light (E). The purpose of the indicator light (E) is to notify the drivers if they are allowed to enter. The indicator light (E) consists of two lamps with two different colors which are red and green. When the card reader (D) detects a valid smartcard, it will send a signal to the indicator light (E) in order to change the red light to the green light so that the driver is allowed to park at the reserved parking. On the other hand, the red light indicates that no parking is allowed at the reserved parking.

Besides that, there is also a sensing device/detector device (B) installed in the system in order to detect the vehicle underneath. The purpose of this device is to detect an unauthorized person who illegally parks inside the reserved parking. The term unauthorized people refers to a non-disabled person or people who does not have the smartcard.

Once the sensing/detector device (B) detects an unauthorized vehicle park inside the reserved parking, it will send a signal to activate the warning light and siren (C) to draw public attention and also notify authorities to take action toward this issue. In contrast, after the authorized driver show his card to the card reader (D) and the indicator light (E) turns to green, the system will be deactivated, and the driver is allowed to park into the reserved parking. Once the sensing/detector device (B) detects the car has left the parking, it will activate the system.

The entire system is run by solar power (F) or electricity depending on the suitability of the place or customer's requirement. A tire stopper (H) is provided to prevent the vehicle from accidentally colliding with the main frame.

1. Main Frame (A)—Functioning as a pole to support overall components which will attached on it.

2. Sensing/Detector Device (B)—Is functioning as sensor to detect vehicle which are located underneath. Object detector can detect whether the vehicle is under it or not and if no vehicle is detected, it will send a signal to indicator light to notice the parking space is closed which indicate turn into red light colour.

3. Warning light/Siren (C)—Serves as a warning indicator in the event of misuse of parking lots by people who do not have authorities/smartcards. This tool will sound a siren when the siren button is activated.

4. Card Reader (D)—Is a tool to identify smartcards and sent signals to the indicator light (E) to open the parking space. It can detect smartcard provided in 3 meter range before driver reached parking lots area. This tool linked to the indicator light (E) using cable and functioning as a brain to the entire system.

5. Indicator Light (E)—Consist of 2 lamps indicator which is green and red. Green lamps activate when the authorities' person enter the parking lots with smartcard identification and red lamp colour indicate the parking lots are closed to unauthorised person.

6. Solar Panel (F)—The system is running using a solar power which will be allocated on top of the pillar

7. Precast concrete foundation (G)—Is provided to make sure of the structure strength and stability. Precast concrete foundation (G) is included of 4 insert bolt and nut and a hole to allowed electricity cable going into it.

8. Tyre stopper (H)—Is provided to prevent vehicle from breaking the main frame. It is made of durable rubber elastic which can last longer and rugged.

9. Smartcard privilege will provided only for the particulars people or authority person such as the authorities (Building security, police etc.), the disable, the owner of the building/apartment etc.

10. Optional item accessories such as CCTV, intercom, LED light are also provided which depends on the requirement or demands from the clients.
